(19) United States
(12) Patent Application Publication
(10) Pub. No.: US 2023/0195681 A1
(43) Pub. Date: Jun. 22, 2023

(54) CIRCUITS AND TECHNIQUES FOR ENHANCED SPI DAISYCHAIN

(71) Applicant: Analog Devices, Inc., Wilmington, MA (US)

(72) Inventors: Gabriele Bernardinis, San Jose, CA (US); Michael Daly, San Jose, CA (US)

(21) Appl. No.: 18/066,741

(22) Filed: Dec. 15, 2022

Related U.S. Application Data
(60) Provisional application No. 63/265,645, filed on Dec. 17, 2021.

(51) Int. Cl. G06F 13/42; G06F 13/362

(52) U.S. Cl. CPC G06F 13/4291; G06F 13/362

(57) ABSTRACT

The present subject matter facilitates chaining of multiple serial peripheral interface (SPI) compliant devices without requiring a bulky clock tree. Generally, in a serial clock distribution scheme as described herein, a fixed pulse based output cock (SCLK_OUT) is synchronized with the data output (SDO) from a respective device in the chain. The SCLK_OUT signal is connected to the SPI clock input (SCLK) of the following downstream device, and SDO is connected to the data input (SDI) of the respective downstream device. This allows the SCLK from the SPI master device to propagate through a theoretically unlimited count of devices in series. The master can resynchronize the MISO data from the SDO of the last part in the chain with the SCLK_OUT signal of the last device in the chain.

### CLAIM OF PRIORITY

This application claims the benefit of priority to U.S. Provisional Pat. Application Serial No. 63/265,645, filed on Dec. 17, 2021, which is hereby incorporated by reference herein in its entirety.

### BACKGROUND

A serial peripheral interface (SPI) is a synchronous serial communication interface traditionally used for short distance communication in a network having a master device and one or more subordinate devices. The SPI is a four-wire interface including a serial clock (SCLK), chip select (CS), and data in (DIN), and data out (DOUT). Data is transmitted serially, device-to-device, to minimize the number of wires in the interface. The clock is distributed in parallel from the master device to each subordinate device. This allows the data to be in synch at all times with the common parallel clock. However, in practice the parallel clocking limits the number of subordinate devices that can be included in the network. If the number of subordinate devices becomes large, the clock signal tree can become challenging to layout and the driver of the clock signal tree can consume too much power.

### FIELD OF THE DISCLOSURE

This document pertains generally, but not by way of limitation, to serial peripheral interfaces (SPIs), and more particularly, techniques for performing clock distribution and synchronization to enhance flexibility or simplify routing in applications where multiple SPI devices are connected serially in a chain.

### BRIEF DESCRIPTION OF THE DRAWINGS

The drawings illustrate generally, by way of example, but not by way of limitation, various embodiments discussed herein. The drawings are not necessarily drawn to scale.

FIG. 1 is a block diagram of an example of a communication network that is SPI compliant.

FIG. 2 is a block diagram of another example of a communication network that is SPI compliant.

FIG. 3 is a circuit diagram showing clock signals propagating through network nodes.

FIG. 4 is a graph of waveforms showing an example of clock signals propagating through circuit diagram of FIG. 3.

FIG. 5 is a graph of waveforms showing another example of clock signals propagating through circuit diagram of FIG. 3.

FIG. 6 is a circuit diagram of an example of an edge-triggered pulse generator circuit.

FIG. 7 is a graph of waveforms illustrating operation of the circuit of FIG. 6.

FIG. 8 illustrates an example of distributing a clock signal in an SPI compliant network.

FIG. 9 is a graph of waveforms showing an example of clock signals propagating through network nodes.

FIG. 10 is another example of an SPI compliant network.

FIG. 11 is a flow diagram of an example of a method of communicating data in a network of network nodes connected serially in a chain.

### DESCRIPTION

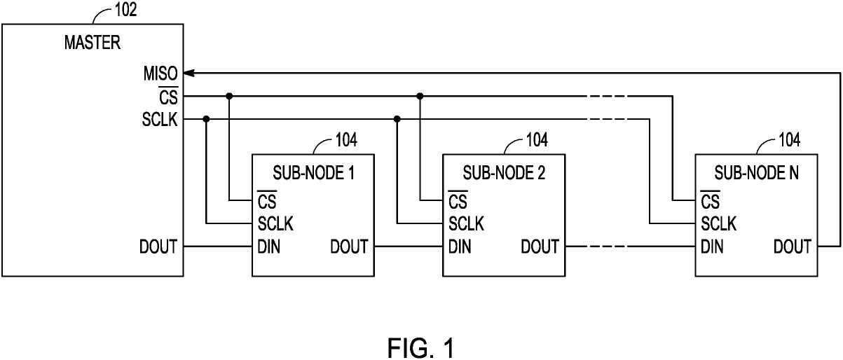

The present subject matter facilitates chaining of multiple serial peripheral interface (SPI) compliant devices without requiring a bulky clock tree. FIG. 1 is a block diagram of an example of a communication network that is SPI compliant. The network includes a master node 102 and N subordinate nodes 104. The network nodes are connected serially in a chain (e.g., a daisy chain connection). Data in the network is distributed serially to the network nodes. The master network node 102 includes a master output subordinate input (MOSI) connection and a master input subordinate output (MISO) connection. The master network node 102 can send serial data to be written to the subordinate network nodes 104 from the MOSI connection and receive serial data from the subordinate network nodes at the MISO connection.

The master node 102 distributes a serial clock (SCLK) in parallel to all of the subordinate nodes 104. Connecting a common network clock using a parallel clock distribution scheme (e.g., a clock tree) to all the subordinate nodes allows the data to always be in sync with the common clock. As long as the delay in the clock tree is less than the maximum delay for acquiring data at the MISO input of the master network node 102, the master network node 102 will be able to latch the data on the MISO input using the distributed clock (SCLK).

However, a parallel clock distribution scheme limits the count of devices that can be included in the chain of devices. Also, for a large number of network nodes, the physical layout of a parallel clock distribution scheme from a master device to a large number of downstream devices becomes complicated. For example, it may be desired to design SPI compliant networks that may include hundreds of network nodes, and the clock tree for such a network may be challenging to route.

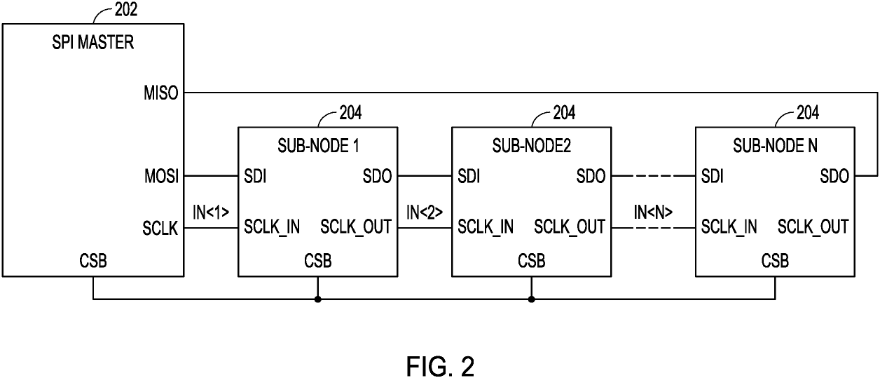

FIG. 2 is an example of an SPI compliant network in which the serial clock signal (SCLK) is distributed serially node-to-node through the chain of network nodes. The master network node provides a master serial clock (SCLK). The clock signal SCLK is received by each subordinate node 204 at a serial clock input (SCLK_IN) from the previous node in the chain and passed to the next node in the chain by a serial clock output (SCLK_OUT). The serial clocking changes the SPI interface of each subordinate node 204 from a four-wire interface to a five-wire interface due to the addition of the serial clock output.

The clock signal can be buffered by each device to provide drive. The problem with simply buffering a clock signal with very high frequency is that there is a limit to the number of devices though the clock can be propagated without eventually violating the setup and hold time requirements at the MISO input of the master network node 202. The delay added by buffering can accumulate as it passes through buffering devices in the chain. If there are hundreds of devices in the chain, the delay from passing through the devices may cause the clock signal to eventually be lost.

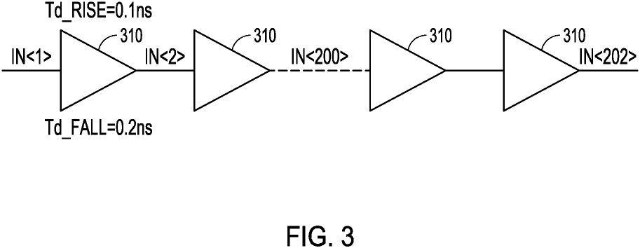

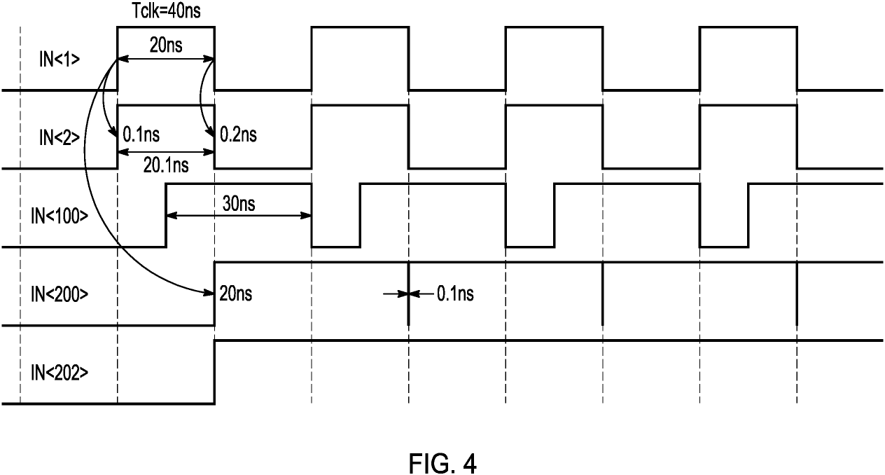

FIG. 3 is a circuit diagram showing clock signals (in<N>) propagating through the buffer circuits 310 of hundreds of network nodes. FIG. 4 is a graph of waveforms showing an example of clock signals (in<N>) propagating through the hundreds of buffering devices of FIG. 3. The clock signal from the master network node (in<1>) has a 40 nanosecond (40 ns) period and a 50% duty cycle. In an actual circuit implementation, there is always a mismatch in the time delay of the rise time (Td_rise) and the time delay of the fall time (Td_fall). In the example of FIGS. 3 and 4, the delay in the rise time (e.g., 0.1 ns) is less than the delay in the fall time (e.g., 0.2 ns). The first buffering device adds delay, and the rising edge of the clock signal is delayed 0.1 ns and falling edge is delayed by 0.2 ns. This causes the duty cycle to change. By the one hundredth device (in<100>), the clock signal duty cycle has changed to 75% and the rising edge is delayed 10 ns. At the two hundredth device (in<200>) the falling edge of the clock signal barely occurs before the rising edge of the next clock signal. Two devices later (in<202>) the clock signal disappears, and the data cannot be latched into the master network node 202.

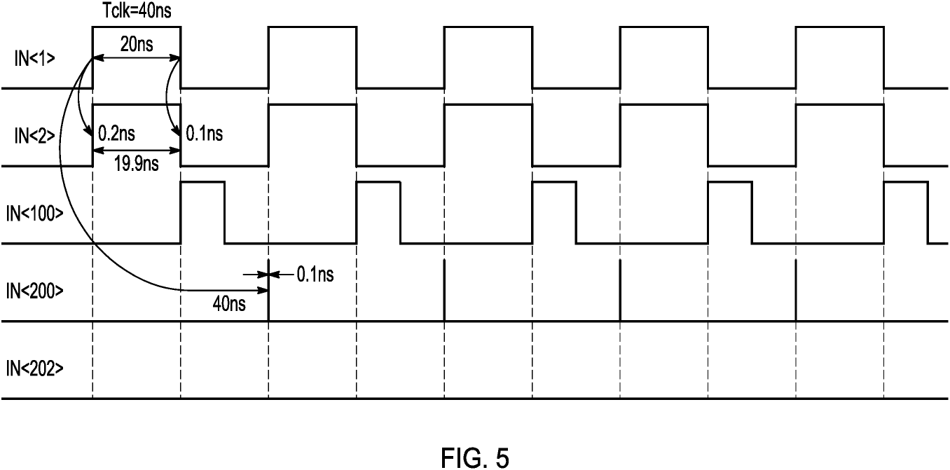

FIG. 5 is a graph of waveforms showing an example of the case where the delay in the rise time (e.g., 0.2 ns) is greater than the delay in the fall time (e.g., 0.1 ns). By the one hundredth device (in<100>), the clock signal duty cycle has changed to 25% and the rising edge is delayed 20 ns. At the two hundredth device (in<200>) the rising edge of the clock signal barely occurs before the falling edge of the next clock signal. Two devices later (in<202>) the clock signal disappears, and the data cannot be latched into the master network node 202.

An improved approach would to be use a latch edge-based circuit element in the network nodes rather than simple buffering. However, using a latch edge based circuit element adds delay to the input clock and data, which does not itself present a problem, but if the rising edge of the clock triggers the latching, the falling edge of the clock signal needs to occur in time before the next rising edge of the next clock for latching data. The same is true for the case where the falling edge triggers the latching; the rising edge of the clock signal needs to occur in time before the next falling edge of the next clock for latching data. In an actual implantation, there can be a delay added by the latching that can accumulate as the clock signal is passed through devices in the chain. If there are hundreds of devices in the chain, the delay from passing through the devices may cause the clock signal to eventually be lost as shown in the examples of FIGS. 4 and 5.

Another approach is to use a phase locked loop (PLL) in the network nodes to synchronize the serial output clock to the serial input clock, thereby guaranteeing zero delay. This would fix the delay issue of the latching approach as it re-times both rising and falling edges to prevent the gradual accumulated drift in rising/falling edge spacing. However, a PLL only works if there is a constant fixed frequency input clock. In this way, the PLL can therefore ‘predict’ when the next input clock is coming in order to generate a zero-delay output clock edge. However, in SPI compliant communications there is not a reliable constant clock. The serial clock (SCLK) is stopped and started as needed, leaving no time for the PLL to adjust to the input clock frequency.

Another approach is for each subordinate node 204 in the network to output a fixed pulse based serial clock on SCLK_OUT to the next network node that is synchronized with sending data on the serial data output (SDO) to the next network node. This allows the SCLK from the master network node 202 to propagate through a theoretically unlimited count of network node connected in series. The master network node 202 resynchronizes the MISO data from the serial data output (SDO) of the last subordinate node 204 in the chain with the serial clock output (SCLK_OUT) of the last subordinate node 204 in the chain. Because the serial clock signal is updated or regenerated at each subordinate network node 204, the clock signal will not disappear due to accumulated delay. Also, the clock signal can be stopped and restarted without changing the reliability of the serial clock signal.

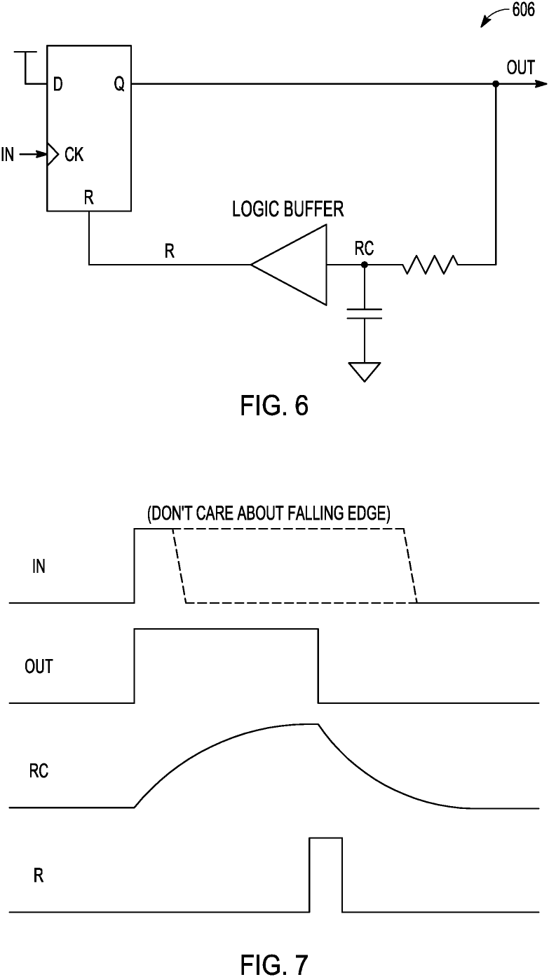

Each subordinate node 204 in the network chain includes an edge-triggered pulse generator circuit to generate the serial clock output (SCLK_OUT) from the serial clock input (SCLK_IN) received from the previous node in the chain. FIG. 6 is a circuit diagram of an example of an edge-triggered pulse generator circuit that is a one-shot circuit 606. FIG. 7 is a graph of waveforms illustrating operation of the one-shot circuit 606. A serial clock is received from the previous network node in the chain and applied to the input (IN) of the one-shot circuit 606. An output having a fixed predetermined pulse width is generated at the output (OUT) of the one-shot circuit 606. The subordinate node also includes logic circuitry to place data on the data output (SDO) of the subordinate node in a predetermined timing relationship to an edge (either rising or falling edge depending on the design) of the serial clock output (SCLK _OUT) of the subordinate node. This allows the data to be reliably clocked by the next network node of the chain even if the next network node is the master network node 202 receiving the serial clock and serial data from the last subordinate node in a chain of hundred or thousands of network nodes.

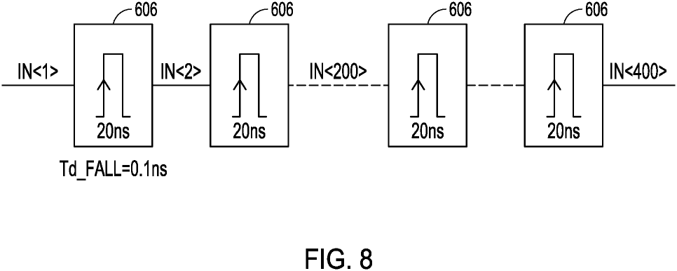

FIG. 8 is an example of an approach to distributing a clock signal in an SPI compliant network having four hundred network nodes, each updating the clock signal (in<N>) for the next node using a one-shot circuit 606. The serial clock is distributed by each subordinate node 204 by generating an updated serial clock using an edge-triggered pulse generator circuit. There is a delay in the rising edge of the pulses, but the delay doesn’t accumulate into a change in the duty cycle and the delay in the falling edge doesn’t matter.

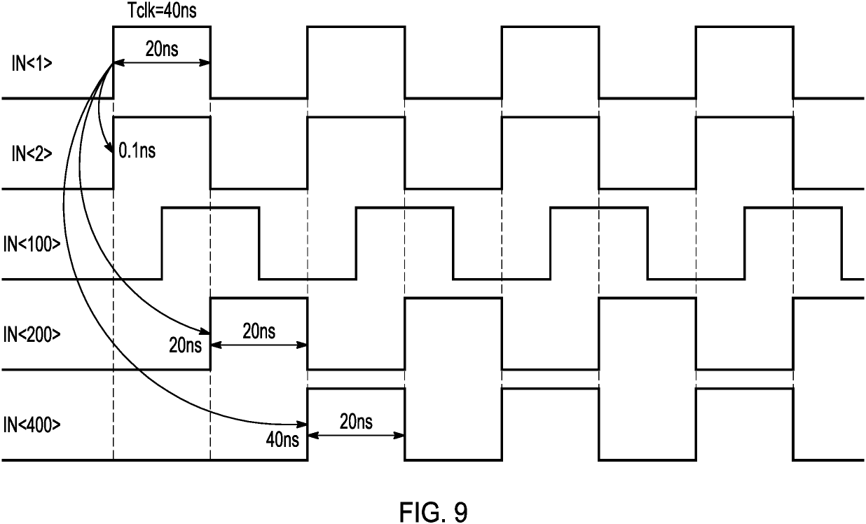

FIG. 9 is a graph of waveforms showing an example of the clock signals (in<N>) propagating through the circuits of FIG. 8. FIG. 9 shows that the clock signal retains the 50% duty cycle throughout the network. If the serial clock output by the last (400th) subordinate node (in<400>) with the serial data out, the master node will reliably capture the data from the last subordinate node no matter what the delay is from the original serial clock output from the master network node 202.

Returning to FIG. 2, the chip select signal (CSB) from the master network node 202 is distributed in parallel to each subordinate node 204. Circuitry (e.g., logic circuitry) of the subordinate node 204 may be activated by a signal received on the chip select input. If it is desired to reduce the chip select tree, the chip select signal could be distributed serially from subordinate node to subordinate node like the data.

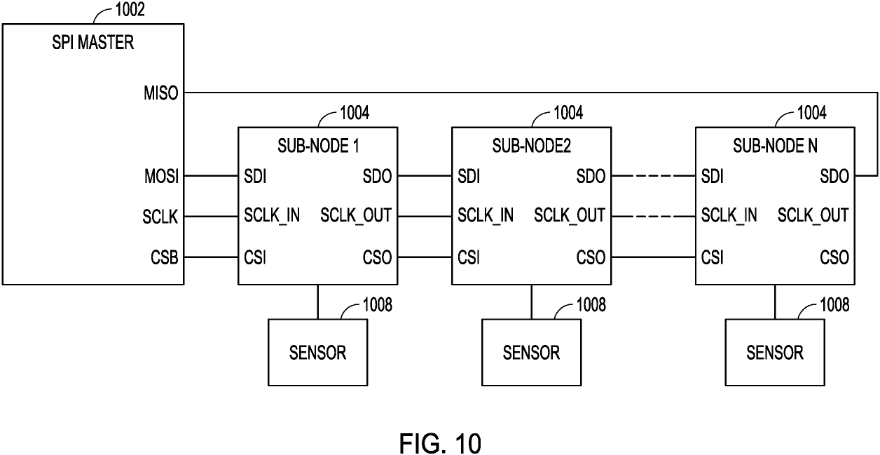

FIG. 10 is another example of an SPI compliant network. The network includes a master network node 1002 and multiple subordinate network nodes 1004. The subordinate nodes 1004 of the network may be connected to sensors 1008 that provide sensor data to the subordinate nodes 1004. In an example intended to be illustrative and non-limiting, the network and sensors can be included in a monitoring system for an automobile. The serial data input of the master node 1002 is connected to the serial data output of a last subordinate node in the chain of network nodes to receive the sensor data serially from the plurality of subordinate nodes.

Like the SPI compliant network of FIG. 2, the clock signal (SCLK) is distributed serially node-to-node in the chain. The subordinate network nodes 1004 include an edge-triggered pulse generator circuit to generate the serial clock output from the serial clock input received from the previous node in the chain. The data is placed on the serial data output synchronized to the serial clock output.

The chip select signal is distributed serially node-to-node in the network. The chip select signal is received from a previous node in the chain in the chip select input (CSI) connection and is sent to the next network node in the chain using the chip select output (CSO) signal. This changes the SPI interface of each subordinate node 904 to a six-wire interface due to the addition of the CSO pin. The received chip select signal may be buffered by the subordinate node 204, and preferably the buffering of the chip select signal adds a delay that matches the delay of the serial clock signal through the subordinate node 204. In some examples, the chip select signal is synchronized internally to the serial clock output like the output data is synchronized.

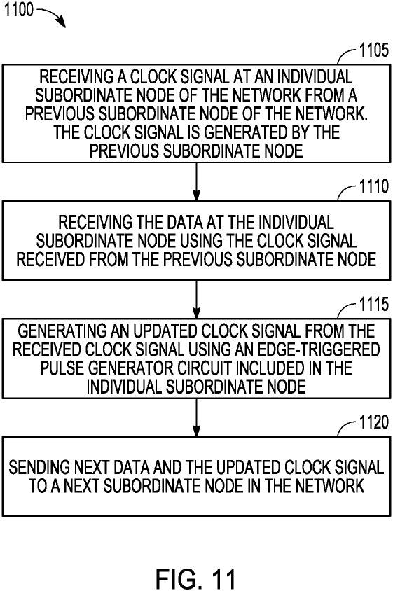

For completeness, FIG. 11 is a flow diagram of an example of a method 1000 of communicating data in a network of network nodes connected serially in a chain, such as the networks of FIGS. 2 and 10. At block 1105, an individual subordinate node of the network receives a clock signal (SCLK_IN) from the previous subordinate node in the chain. The clock signal is generated by the previous subordinate node.

At block 1110, the individual subordinate node receives data (SDI) from the previous subordinate node in the chain. The data is received by latching the data using the clock signal received from the previous subordinate node in the chain.

At block 1115, the individual subordinate node generates an updated clock signal from the received clock signal. The updated clock signal is generated using an edge-triggered pulse generator circuit included in the individual subordinate node. At block 1120, the individual subordinate sends next data (SDO) and the updated clock signal (SCLK_OUT) to the next subordinate node in the chain. If the individual subordinate node is the last subordinate node in the chain, the individual subordinate sends next data and the updated clock signal to the master network node.

The clocking technique allows for an SPI compliant network of any number of nodes, including networks with hundreds or thousands of network nodes. A network could be implemented with a combination of parallel clocking and serial clocking. The chip select signal could be distributed serially or in parallel or a combination of serial and parallel.

The following are example embodiments of systems and methods of operation, in accordance with the teachings herein.

Example 1 includes subject matter (such as a serial communication network) comprising multiple network nodes connected serially as a chain of network nodes. Each network node includes a serial data input to receive data from a previous node in the chain; a serial clock input to receive a clock signal from a previous node in the chain; an edge-triggered pulse generator circuit configured to generate an updated clock signal from the clock signal received at the serial clock input; and logic circuitry configured to send the updated clock signal on a serial clock output of the network node to the serial clock input of the next network node in the chain and send the data on a serial data output of the network node to the serial data input of a next network node in the chain in a predetermined time relationship to sending the updated clock signal.

In Example 2, the subject matter of Example 1 optionally includes network nodes that include a master network node, and the clock signal originates from serial clock output of the master network node. The master network node optionally includes a serial clock input connected to a serial clock output of a last network node of the multiple network node, and a serial data input connected to a serial data output of the last network node of the multiple network nodes.

In Example 3, the subject matter of Example 2 optionally includes a master network node that includes a chip select output, and the other network nodes of the multiple network nodes include a chip select input connected to the chip select output of the master network node.

In Example 4, the subject matter of Example 3 optionally includes the other network nodes of the multiple network nodes include a five-wire interface.

In Example 5, the subject matter of Example 1 optionally includes the multiple network nodes including a master network node, and the other network nodes of the multiple network nodes include a chip select input and a chip select output. The chip select input of a network node is connected to a chip select output of a previous network node and the chip select output of the network node is connected to the ship select input of the next network node.

In Example 6, the subject matter of Example 5 optionally includes the other network nodes of the multiple network nodes including a six-wire interface.

In Example 7, the subject matter of one or any combination of Examples 1-6 optionally includes a a master network node to generate a master serial clock signal, and the other network nodes of the multiple network nodes include a one-shot circuit as the edge triggered pulse generator circuit to generate an updated serial clock signal having a predetermined pulse width.

In Example 8, the subject matter of one or any combination of Examples 1-7 optionally includes a master network node and subordinate network nodes. Multiple subordinate network nodes are each connected to a sensor to provide sensor data to the subordinate node, and the serial data input of the master node is connected to the serial data output of a last subordinate node in the chain of network nodes to receive the sensor data serially from the plurality of subordinate nodes.

Example 9 includes subject matter (such as a method of communicating data in a network of network nodes connected serially in a chain) or can optionally be combined with one or any combination of Examples 1-8 to include such subject matter, comprising receiving a clock signal at an individual subordinate node of the network from a previous subordinate node of the network, wherein the clock signal is generated by the previous subordinate node; receiving the data at the individual subordinate node using the clock signal received from the previous subordinate node; generating an updated clock signal from the received clock signal using an edge-triggered pulse generator circuit included in the individual subordinate node; and sending next data and the updated clock signal to a next subordinate node in the network.

In Example 10, the subject matter of Example 9 optionally includes generating first data and a first clock signal using a master node of the network; generating a last updated clock signal by a last subordinate node in the network using a clock signal received from previous-to-last subordinate node of the network; sending last data and the last updated clock signal to the master node; and receiving, by the master node, the last data using the last updated clock signal.

In Example 11, the subject matter of one or both of Examples 9 and 10 optionally include sending, by a master node of the network, a chip select signal in parallel to all subordinate nodes of the network.

In Example 12, the subject matter of one or both of Examples 9 and 10 optionally includes receiving, by the individual subordinate node, a chip select signal from the previous subordinate node; and sending a chip select with the next data and the updated clock signal to the next subordinate node in the network.

In Example 13, the subject matter of one or any combination of Examples 9-12 optionally includes generating an updated clock signal having a predetermined pulse width using a one-shot circuit included in the individual subordinate node.

In Example 14, the subject matter of one or any combination of Examples 9-13 optionally includes updating the clock signal by a one-hundredth subordinate node of the network.

Example 15 includes subject matter (such as a subordinate network device for a serial peripheral interface (SPI)), or can optionally be combined with one or any combination of Examples 1-14 to include such subject matter, comprising a serial data input to receive data; a serial data output; a serial clock input; an edge-triggered pulse generator circuit configured to generate an updated clock signal from a clock signal received at the serial clock input; and logic circuitry configured to send the updated clock signal on the serial clock output and send the data on the serial data output in a predetermined time relationship to sending the updated clock signal.

In Example 16, the subject matter of Example 15 optionally includes a chip select input, wherein the logic circuitry is enabled by a signal received on the chip select input.

In Example 17, the subject matter of one or both of Examples 15 and 16 optionally includes an SPI that is a five-wire interface.

In Example 18, the subject matter of one or both of Examples 15 and 16 optionally includes a chip select output, wherein the logic circuitry is configured to send a chip select signal on the chip select output in a predetermined time relationship to sending the updated clock signal.

In Example 19, the subject matter of one or any combination of Examples 15, 16 and 18 optionally includes an SPI that is a six-wire interface.

In Example 20, the subject matter of one or any combination of Examples 15-19 optionally includes a one-shot circuit configured to generate a clock pulse of a predetermined pulse width on the serial clock output.

Each of the non-limiting aspects described herein can stand on its own or can be combined in various permutations or combinations with one or more of the other aspects or other subject matter described in this document. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, nontransitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A serial communication network, the network comprising:
multiple network nodes connected serially as a chain of network nodes, wherein each network node includes:
a serial data input to receive data from a previous node in the chain;
a serial clock input to receive a clock signal from a previous node in the chain;
an edge-triggered pulse generator circuit configured to generate an updated clock signal from the clock signal received at the serial clock input; and
logic circuitry configured to send the updated clock signal on a serial clock output of the network node to the serial clock input of the next network node in the chain and send the data on a serial data output of the network node to the serial data input of a next network node in the chain in a predetermined time relationship to sending the updated clock signal.

2. The network of claim 1,
wherein the multiple network nodes include a master network node, and the clock signal originates from serial clock output of the master network node; and
wherein the master network node includes a serial clock input connected to a serial clock output of a last network node of the multiple network node, and a serial data input connected to a serial data output of the last network node of the multiple network nodes.

3. The network of claim 2, wherein the master network node that includes a chip select output, and the other network nodes of the multiple network nodes include a chip select input connected to the chip select output of the master network node.

4. The network of claim 3, wherein the other network nodes of the multiple network nodes include a five-wire interface.

5. The network of claim 1, wherein the multiple network nodes include a master network node, and the other network nodes of the multiple network nodes include a chip select input and a chip select output; wherein the chip select input of a network node is connected to a chip select output of a previous network node and the chip select output of the network node is connected to the ship select input of the next network node.

6. The network of claim 5, wherein the other network nodes of the multiple network nodes include a six-wire interface.

7. The network of claim 1, wherein the multiple network nodes include a master network node to generate a master serial clock signal, and the other network nodes of the multiple network nodes include a one-shot circuit as the edge triggered pulse generator circuit to generate an updated serial clock signal having a predetermined pulse width.

8. The network of claim 1,
wherein the multiple network nodes include a master network node and subordinate network nodes;
wherein a plurality of the subordinate network nodes are each connected to a sensor to provide sensor data to the subordinate node; and
wherein the serial data input of the master node is connected to the serial data output of a last subordinate node in the chain of network nodes to receive the sensor data serially from the plurality of subordinate nodes.

9. A method of communicating data in a network of network nodes connected serially in a chain, the method comprising:
receiving a clock signal at an individual subordinate node of the network from a previous subordinate node of the network, wherein the clock signal is generated by the previous subordinate node;
receiving the data at the individual subordinate node using the clock signal received from the previous subordinate node;
generating an updated clock signal from the received clock signal using an edge-triggered pulse generator circuit included in the individual subordinate node; and
sending next data and the updated clock signal to a next subordinate node in the network.

10. The method of claim 9, including:
generating first data and a first clock signal using a master node of the network;
generating a last updated clock signal by a last subordinate node in the network using a clock signal received from previous-to-last subordinate node of the network;
sending last data and the last updated clock signal to the master node; and
receiving, by the master node, the last data using the last updated clock signal.

11. The method of claim 9, including sending, by a master node of the network, a chip select signal in parallel to all subordinate nodes of the network.

12. The method of claim 9, including:
receiving, by the individual subordinate node, a chip select signal from the previous subordinate node; and
sending a chip select with the next data and the updated clock signal to the next subordinate node in the network.

13. The method of claim 9, wherein generating the updated clock signal includes generating an updated clock signal having a predetermined pulse width using a one-shot circuit included in the individual subordinate node.

14. The method of claim 9, wherein the updating the clock signal at the individual subordinate node of the network includes updating the clock signal by a one-hundredth subordinate node of the network.

15. A subordinate network device for a serial peripheral interface (SPI), the device comprising:
a serial data input to receive data;
a serial data output;
a serial clock input;
an edge-triggered pulse generator circuit configured to generate an updated clock signal from a clock signal received at the serial clock input;
a serial clock output; and
logic circuitry configured to send the updated clock signal on the serial clock output and send the data on the serial data output in a predetermined time relationship to sending the updated clock signal.

16. The device of claim 15, including a chip select input, wherein the logic circuitry is enabled by a signal received on the chip select input.

17. The device of claim 16, wherein the SPI is a five-wire interface.

18. The device of claim 16, including a chip select output, wherein the logic circuitry is configured to send a chip select signal on the chip select output in a predetermined time relationship to sending the updated clock signal.

19. The device of claim 18, wherein the SPI is a six-wire interface.

20. The device of claim 15, wherein edge-triggered pulse generator circuit includes a one-shot circuit configured to generate a clock pulse of a predetermined pulse width on the serial clock output.
